(19) United States
(12) Patent Application Publication
(10) Pub. No.: US 2013/0147741 A1
(43) Pub. Date: Jun. 13, 2013

(54) INTERLACE ROW SCAN

(71) Applicant: STMicroelectronics Asia Pacific Pte Ltd., Singapore (SG)

(72) Inventors: NeeLoong Wilson LOW, Singapore (SG); Hup-Peng GOH, Singapore (SG)

(73) Assignee: STMICROELECTRONICS ASIA PACIFIC PTE LTD., Singapore (SG)

(21) Appl. No.: 13/712,275

(22) Filed: Dec. 12, 2012

Related U.S. Application Data
(60) Provisional application No. 61/570,137, filed on Dec. 13, 2011.

(51) Int. Cl. G06F 3/041

(52) U.S. Cl. CPC G06F 3/041
USPC 345/173

(57) ABSTRACT

A touch screen panel is operated with an interlaced scanning pattern. All of the even rows are scanned first, followed by all of the odd rows. The interlacing method reduces the chance of a slow response due to a missed scan by 50%. The interlacing method can expanded to scan every other 3rd line or 4th line for further improvement in performance.

### RELATED APPLICATION

The present invention claims priority from U.S. Provisional Patent Application Ser. No. 61/570,137 filed Dec. 13, 2011, and is incorporated herein by reference in its entirety for all purposes as if fully set forth herein.

### FIELD OF THE INVENTION

The present invention is related to touch screen controllers, and methods for improving the response time thereof.

### BACKGROUND OF THE INVENTION

The response time of a touch controller ASIC is directly proportional to the number of lines the ASIC needs to process. Part of the processing time involves the scanning of the touch panel. However, the rows on the touch panel are scanned sequentially thus if the current scan line just misses the touched line, this touch will only be detected on the next frame scan.

The frame for touch panel 100 shown in FIG. 1 is scanned from top to bottom sequentially. In the example of FIG. 1, the frame is scanned from line 0 followed by line 1 until line 22. This scanned data from the frame then goes through heavy computation to detect a touch 102. Depending on the panel size, resolution and processing speed, the top nodes (nodes on line 0 and 1) will not be scanned for another 10 s of millisecond.

What is desired is a method for improving the touch speed of a touch controller without the expense of additional hardware or software as compared to the prior art sequential method.

### SUMMARY OF THE INVENTION

According to the present invention, a method of operating a touch controller comprises detecting a touch using an interlaced scan pattern. The touch controller comprises a plurality of even rows and a plurality of odd rows and wherein all of the even rows are scanned first, and then all of the odd rows are scanned. In the alternative, the touch controller comprises a plurality of rows, and wherein every Nth row is scanned on a first scanning pass. Every incremental Nth row is scanned on subsequent scanning passes. The value of N can be three or four. If no touch is detected after a predetermined time period, the touch controller switches from a fast scan mode to a slow scan mode. The fast scan mode is about 12 msec per frame, and the slow scan mode is about 36 msec per frame. A digital portion of the touch controller is put on standby during the slow scan mode. The digital portion of the touch controller is reactivated if a subsequent touch is detected.

### BRIEF DESCRIPTION OF THE DRAWINGS

FIG. 1 is a schematic diagram of a touch panel according to the prior art in which every row in a frame is scanned sequentially from the top to the bottom;

FIG. 2 is a schematic diagram of a touch panel according to the prior art in which the rows in a frame are scanned in an interlaced pattern according to an embodiment of the invention;

FIG. 3 is a flow chart of operational modes of the touch controller according to an embodiment of the present invention including a slow scan mode and a fast scan mode; and

FIG. 4 is a block diagram of the touch controller according to an embodiment of the present invention showing corresponding digital and analog circuitry.

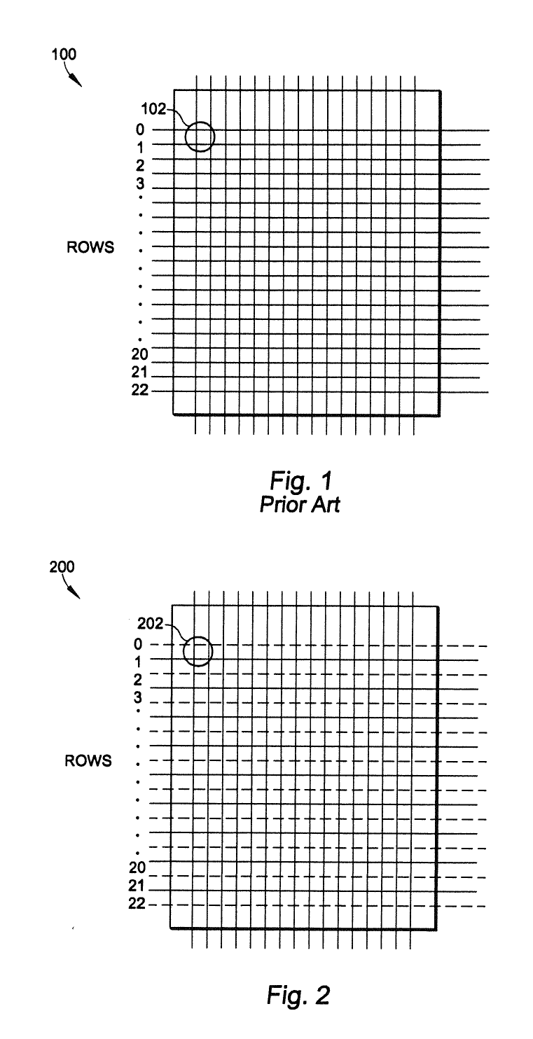

### DETAILED DESCRIPTION

Referring now to FIG. 2, instead of scanning sequentially, the touch panel 200 scanning pattern is interlaced. This means that all the even rows are scanned first followed by the odd rows. Thus, if the touch 202 occurs at the starting scan time of row 2, the second pass that scans the odd rows will pick up the touch and respond accordingly. This reduces the chance of a slow response due to a “missed” scan by 50%. This method can expand to scan every other 3rd line or 4th line for further improvement.

The method of the present invention improves the response time of the touch controller ASIC, and does not require any additional hardware or software compared to a sequential scan.

A fast scan involves scanning every line for each frame of the touch screen. The frame rate is, for example, 12 msec. The digital and analog circuitries of the touch controller are both active during a fast scan. Current consumption is therefore large.

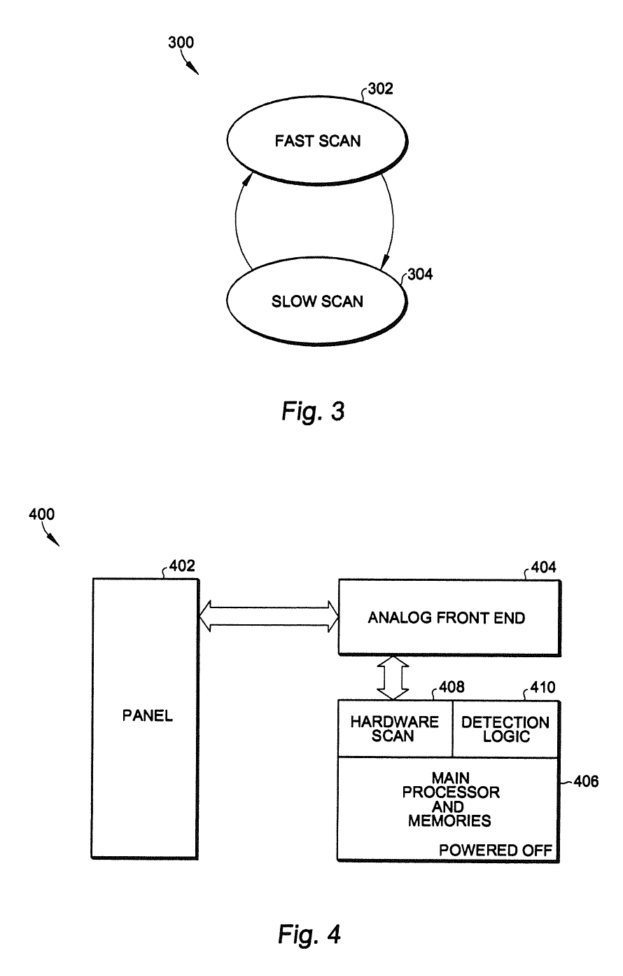

Referring now to the block diagram 300 of FIG. 3, if no touch is detected after a predetermined time period, the touch controller will switch from the fast scan operational mode 302 to a “slow scan” operational mode 304, where the frame rate is reduced to, for example, 36 msec. With a slower frame rate as compared to when in “fast scan” mode wherein every line is scanned in sequence, we would expect current drawn by the touch controller to be substantially reduced. This was found not to be the case as the digital circuitry is still active during the scan. To further reduce the current consumption, the digital circuitry is put on standby except for a smaller “touch detection” circuit and interlace scanning, as described above, is carried out. When a touch is detected, the touch controller is brought from the standby state to the active state. The touch controller then switches back to the “fast scan” mode to detect and report the touch image.

FIG. 4 is a block diagram of the touch controller 400 according to an embodiment of the present invention showing corresponding digital and analog circuitry. The touch controller 400 includes the touch panel 402 in communication with the analog front end 404, which in turn is in communication with a digital circuit block including the hardware scan circuitry 408, the detection logic 410, and the main processor and memories 406. The main processor and memory block 406 can be powered down as discussed above.

It will be apparent to those skilled in the art, therefore that various modifications and variations can be made to the invention without departing from the spirit or scope of the invention. Thus, it is intended that the present invention covers the modifications and variations of this invention provided they come within the scope of the appended claims.

We claim:

1. A method of operating a touch controller comprising detecting a touch using an interlaced scan pattern.

2. The method of claim 1 wherein the touch controller comprises a plurality of even rows and a plurality of odd rows and wherein all of the even rows are scanned first, and then all of the odd rows are scanned.

3. The method of claim 1 wherein the touch controller comprises a plurality of rows, and wherein every Nth row is scanned on a first scanning pass.

4. The method of claim 3 wherein every incremental Nth row is scanned on subsequent scanning passes.

5. The method of claim 3 wherein N is equal to three.

6. The method of claim 3 wherein N is equal to four.

7. The method of claim 1, wherein, if no touch is detected after a predetermined time period, the touch controller switches from a fast scan mode to a slow scan mode.

8. The method of claim 7 wherein a frame rate of the fast scan mode is about 12 msec per frame.

9. The method of claim 7 wherein a frame rate of the slow scan mode is about 36 msec per frame.

10. The method of claim 7 wherein a digital portion of the touch controller is put on standby during the slow scan mode.

11. The method of claim 10 wherein the digital portion of the touch controller is reactivated if a subsequent touch is detected.

12. A touch controller comprising an interlaced scan pattern for detecting a touch.

13. The touch controller of claim 12 comprising a plurality of even rows and a plurality of odd rows wherein all of the even rows are scanned first, and then all of the odd rows are scanned.

14. The touch controller of claim 12 comprising a plurality of rows, and wherein every Nth row is scanned on a first scanning pass.

15. The touch controller of claim 14 wherein every incremental Nth row is scanned on subsequent scanning passes.

16. The touch controller of claim 14 wherein N is equal to three.

17. The touch controller of claim 14 wherein N is equal to four.

18. The touch controller of claim 12, wherein, if no touch is detected after a predetermined time period, the touch controller switches from a fast scan mode to a slow scan mode.

19. The touch controller of claim 18 wherein a frame rate of the fast scan mode is about 12 msec per frame.

20. The touch controller of claim 18 wherein a frame rate of the slow scan mode is about 36 msec per frame.

21. The touch controller of claim 18 wherein a digital portion of the touch controller is put on standby during the slow scan mode.

22. The touch controller of claim 21 wherein the digital portion of the touch controller is reactivated if a subsequent touch is detected.
